(19) United States
(12) Patent Application Publication
(10) Pub. No.: US 2015/0345564 A1
(43) Pub. Date: Dec. 3, 2015

(54) ROTATING WHEEL MOUNTING STRUCTURE

(71) Applicant: Yung Li Hsing Electric Works Co., Ltd, Taichung Dist., (TW)

(72) Inventors: Li-Wen CHANG, Taichung City (TW); Chris LIN, Taichung City (TW); Kolin KUO, Taichung City (TW)

(73) Assignee: Yung Li Hsing Electric Works Co., Ltd, Taichung Dist., (TW)

(21) Appl. No.: 14/293,515

(22) Filed: Jun. 2, 2014

(51) Int. Cl. F16D 1/08; B24B 45/00

(52) U.S. Cl. CPC F16D 1/0847; B24B 45/00

(57) ABSTRACT

A rotating wheel mounting structure includes a rotating shaft having a key slot, a rotating wheel mounted on the rotating shaft, a locating member mounted on the rotating shaft and stopped at one side of the rotating wheel, a locating member mounted on the rotating shaft and fastened to the key slot, and a lock member fastened to the rotating shaft to lock the locating member and the rotating wheel, and thus fixation between the locating member and the rotating shaft prohibits the lock member from being rotated in the reversed direction and loosened due to an inertia on the rotating wheel.

### BACKGROUND OF THE INVENTION

1. Field of the Invention

The present invention relates to rotary machine tools and more particularly, to a rotating wheel mounting structure.

2. Description of the Related Art

Currently, many machine tools use a rotating wheel for different applications, for example, a sand wheel in a sander, a grinding wheel in a grinding machine, or a drive wheel in a band saw. These machine tools commonly use a power drive, for example, a motor to rotate a rotating shaft, thereby rotating the rotating wheel for processing. As illustrated in FIG. 1, the rotating wheel 10 is mounted on a rotating shaft 11 that is connected to and rotatable by a power drive (not shown). Further, two gaskets 12 are mounted on the rotating shaft 11 and respectively abutted at two opposite sides of the rotating wheel 10. Further, a lock member 13 is threaded onto the rotating shaft 11 and stopped at one gasket 12 against the rotating wheel 10, enabling the gasket 12 be firmly secured to the rotating shaft 11 for synchronous rotation.

The aforesaid rotating wheel mounting structure is functional; however, when the power drive is switched between a high speed mode and a low speed mode, a connection problem between the lock member and the rotating wheel can occur. Because the rotating wheel is heavy and its rotating speed is fast. When the rotating speed of the rotating wheel is changed from a high level to a low level, for example, changed from 3600 rpm to 1200 rpm, the rotating shaft can be quickly changed from high speed to low speed; however the rotating speed of the rotating wheel cannot be rapidly reduced due to inertia. At this time, the gasket and the lock member can be rotated in the reversed direction and loosened. In order to prevent the occurrence of this problem, it is the normal way to bond the lock member to the rotating shaft with an adhesive or to affix the lock member to the rotating shaft by rivets. These measures can prevent loosening of the lock member and the gasket; however these measures will make the rotating wheel dismountable, causing a rotating wheel repair problem.

### SUMMARY OF THE INVENTION

The present invention has been accomplished under the circumstances in view. It is the main object of the present invention to provide a rotating wheel mounting structure, which assures fixation accuracy of the rotating wheel and simplifies its dismounting.

To achieve this and other objects of the present invention, a rotating wheel mounting structure of the invention comprises a rotating shaft having a key slot, a rotating wheel mounted on the rotating shaft, a locating member mounted on the rotating shaft at one side of the rotating wheel and fastened to the key slot of the locating member, and a lock member fastened to the rotating shaft to lock the locating member and the rotating wheel. Fixation between the locating member and the rotating shaft can prohibit the rotating wheel from reverse rotation due to inertia, preventing the lock member from being rotated in the reversed direction and loosened.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a front view of a rotating wheel mounting structure according to the prior art.

FIG. 2 is a front view of a rotating wheel mounting structure in accordance with a first embodiment of the present invention.

FIG. 3 is a sectional view taken along line 2-2 of FIG. 2.

FIG. 4 is an exploded view of a part of the rotating wheel mounting structure in accordance with the first embodiment of the present invention.

FIG. 5 is a front view of a rotating wheel mounting structure in accordance with a second embodiment of the present invention.

FIG. 6 is a front view of a rotating wheel mounting structure in accordance with a third embodiment of the present invention.

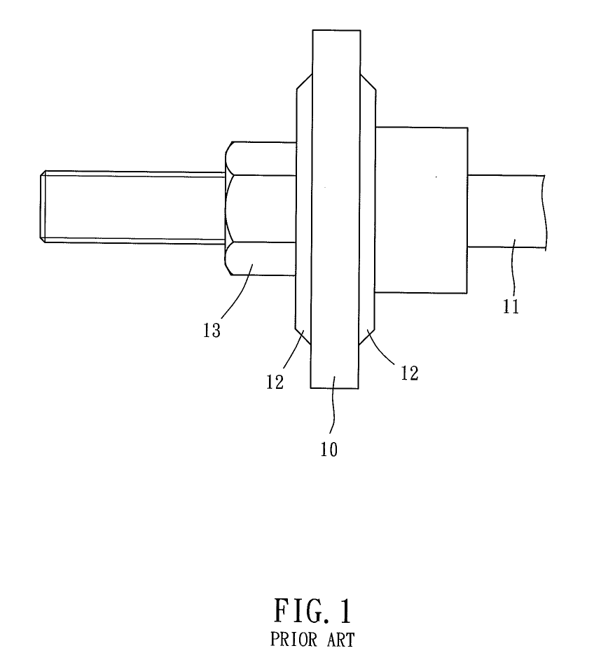

### DETAILED DESCRIPTION OF THE INVENTION

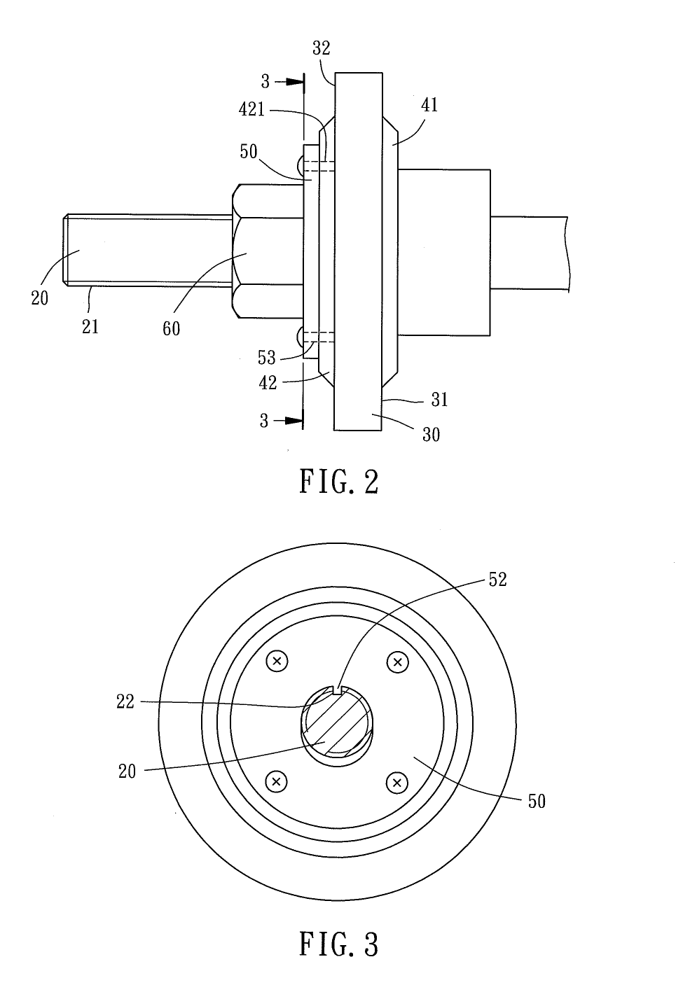

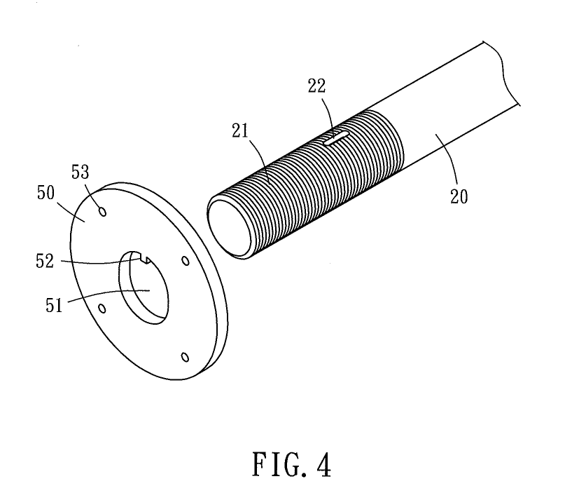

Referring to FIGS. 2-4, a rotating wheel mounting structure in accordance with a first embodiment of the present invention is shown. The rotating wheel mounting structure comprises:

a rotating shaft 20 connected to and rotatable by a power drive (not shown), comprising a threaded segment 21, a circular or elongated key slot, for example, an elongated key slot 22 located in the periphery thereof an extending along the length of the rotating shaft 20;

a rotating wheel 30 mounted around the rotating shaft 20, comprising an inner wall 31 facing toward an inner end of the rotating shaft 20 that is connected to the power drive and an opposing outer wall 32 facing toward an opposing outer end of the rotating shaft 20;

an inner gasket 41 and an outer gasket 42 mounted on the rotating shaft 20 and respectively attached to the inner wall 31 and outer wall 32 of the rotating wheel 30;

a locating member 50 comprising a through hole 51 sleeved onto the rotating shaft 20, an engagement key 52 protruded from an inner perimeter thereof and extending in direction toward the center of the through hole 51 and engaged into the key slot 22 of the rotating shaft 20, and at least one, for example, four connection portions 53 made in the form of, for example, a through hole and respectively fastened to a respective screw hole 421 in the outer gasket 42 by a respective screw to secure the locating member 50 to the outer gasket 42; and

a lock member 60 threaded onto the threaded segment 21 of the rotating shaft 20 and stopped at the locating member 50 against the outer gasket 42 and the rotating wheel 30.

When the power drive is switched from a high speed mode to a low speed mode, there is still a certain inertia on the rotating wheel; however, the rotating wheel will not drive the outer gasket in the reversed direction. Because the outer gasket is affixed to the connection portions of the locating member and the engagement key of the locating member is fastened to the rotating shaft, the locating member can stop the outer gasket from reverse rotation, preventing the lock member from being rotated in the reversed direction and loosened. Thus, the invention effectively improves the drawback of the prior art design.

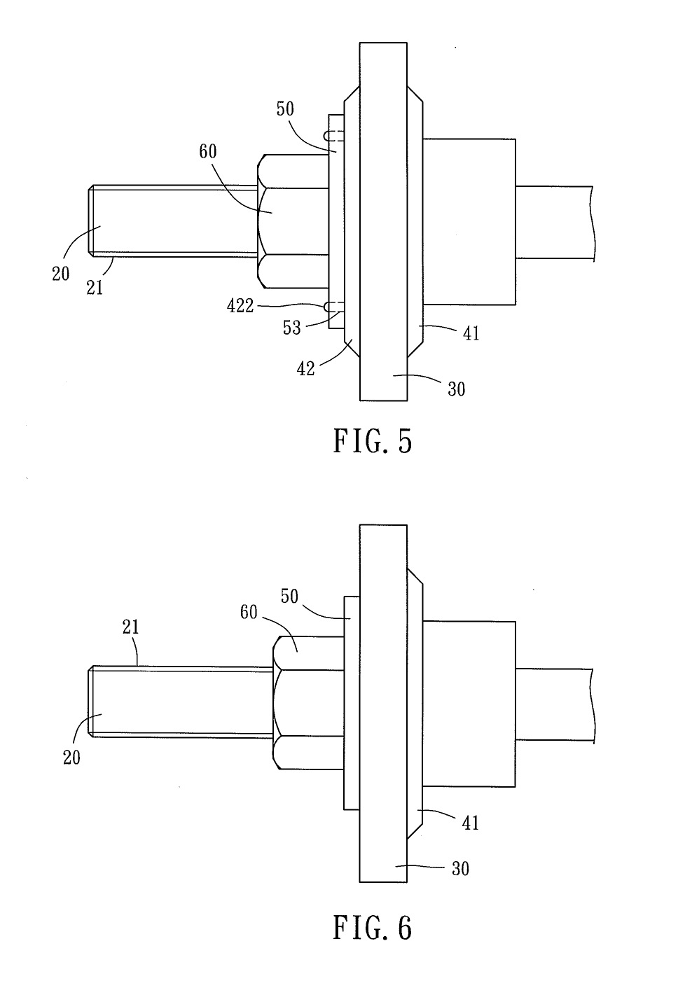

Referring to FIG. 5, a rotating wheel mounting structure in accordance with a second embodiment of the present invention is shown. The rotating wheel mounting structure comprises:

a rotating shaft 20 connected to and rotatable by a power drive (not shown), comprising a threaded segment 21 and a key slot 22;

a rotating wheel 30 mounted around the rotating shaft 20, comprising an inner wall 31 facing toward an inner end of the rotating shaft 20 that is connected to the power drive and an opposing outer wall 32 facing toward an opposing outer end of the rotating shaft 20;

an inner gasket 41 and an outer gasket 42 mounted on the rotating shaft 20 and respectively attached to the inner wall 31 and outer wall 32 of the rotating wheel 30;

a locating member 50 comprising a through hole 51 sleeved onto the rotating shaft 20, an engagement key 52 protruded from an inner perimeter thereof and extending in direction toward the center of the through hole 51 and engaged into the key slot 22 of the rotating shaft 20, and at least one connection portion 53 made in the form of for example, a pinhole and respectively fastened to a respective pin 422 at the outer gasket 42 to secure the locating member 50 to the outer gasket 42 and to prohibit the outer gasket 42 from a rotary motion relative to the locating member 50; and

a lock member 60 threaded onto the threaded segment 21 of the rotating shaft 20 and stopped at the locating member 50 against the outer gasket 42 and the rotating wheel 30.

When the power drive is switched from a high speed mode to a low speed mode, there is still a certain inertia on the rotating wheel; however, the rotating wheel 30 will not drive the outer gasket 42 in the reversed direction. Because the at least one pin 422 of outer gasket 42 is respectively fastened to the connection portions 53 of the locating member 50 and the engagement key 52 of the locating member 50 is fastened to the rotating shaft 20, the locating member 50 can stop the outer gasket 42 from reverse rotation, preventing the lock member 50 from being rotated in the reversed direction and loosened. When compared to the aforesaid first embodiment, the connection arrangement between the locating member 50 and the outer gasket 42 in accordance with this second embodiment is simpler without using any screw, facilitating the installation.

Referring to FIG. 6, a rotating wheel mounting structure in accordance with a third embodiment of the present invention is shown. The rotating wheel mounting structure comprises:

a rotating shaft 20 connected to and rotatable by a power drive (not shown), comprising a threaded segment 21 and a key slot 22;

a rotating wheel 30 mounted around the rotating shaft 20, comprising an inner wall 31 facing toward an inner end of the rotating shaft 20 that is connected to the power drive and an opposing outer wall 32 facing toward an opposing outer end of the rotating shaft 20;

an inner gasket 41 mounted on the rotating shaft 20 and attached to the inner wall 31 of the rotating wheel 30;

a locating member 50 mounted on the rotating shaft 20 and stopped against the outer wall 32 of the rotating wheel 30, comprising a through hole 51 for the passing of the rotating shaft 20 and an engagement key 52 protruded from an inner perimeter thereof and extending in direction toward the center of the through hole 51 and engaged into the key slot 22 of the rotating shaft 20; and

a lock member 60 threaded onto the threaded segment 21 of the rotating shaft 20 and stopped against the locating member 50.

This third embodiment eliminates the arrangement of the outer gasket at the outer wall 32 of the rotating wheel 30, and has the locating member 50 be directly mounted on the rotating shaft 20, i.e., the locating member 50 simultaneously provides the function of a locating member and the function of gasket. This third embodiment reduces the amount of component parts; however, because the locating member 50 and the rotating shaft 20 are fastened together, and the locating member 50 is held down on the rotating wheel 30 by the lock member 60, the rotating wheel 30 is firmly secured to the shaft 20. When an inertia is produced on the rotating wheel 30, the locating member 50 will not be rotated, preventing the lock member 60 from being loosened.

Although particular embodiments of the invention has been described in detail for purposes of illustration, various modifications and enhancements may be made without departing from the spirit and scope of the invention. Accordingly, the invention is not to be limited except as by the appended claims.

What is claimed is:

1. A rotating wheel mounting structure, comprising:
a rotating shaft comprising a threaded segment and a key slot;
a rotating wheel mounted on said rotating shaft, said rotating wheel comprising an inner wall and an opposing outer wall;
an inner gasket mounted on said rotating shaft and attached to said inner wall of said rotating wheel;
a locating member mounted on said rotating shaft and stopped against said outer wall of said rotating wheel, said locating member comprising an engagement key fastened to said key slot of said rotating shaft; and
a lock member fastened to said threaded segment of said rotating shaft and stopped against said locating member.

2. The rotating wheel mounting structure as claimed in claim 1, wherein said key slot is an elongated key slot extending along the length of said rotating shaft.

3. The rotating wheel mounting structure as claimed in claim 1, further comprising an outer gasket mounted on said rotating shaft and set between said outer wall of said rotating wheel and said locating member.

4. The rotating wheel mounting structure as claimed in claim 3, wherein said locating member comprises at least one connection portion fastened to said outer gasket.

5. The rotating wheel mounting structure as claimed in claim 4, wherein each said connection portion is a through hole; said outer gasket comprises at least one pin respectively press-fitted into said at least one connection portion of said locating member to prohibit said outer gasket from a rotary motion relative to said locating member.

6. The rotating wheel mounting structure as claimed in claim 4, wherein each said connection portion is a through hole; said outer gasket comprises at least one screw hole respectively fastened to said at least one connection portion of said locating member by a respective screw to prohibit said outer gasket from a rotary motion relative to said locating member.

7. The rotating wheel mounting structure as claimed in claim 5, wherein said key slot is an elongated key slot extending along the length of said rotating shaft.

8. The rotating wheel mounting structure as claimed in claim 1, wherein said locating member comprises a through hole; said engagement key is extended from an inner perimeter of said locating member and suspending in said through hole of said locating member at one side.

9. The rotating wheel mounting structure as claimed in claim 8, wherein said through hole of said locating member is coupled to said rotating shaft for enabling said engagement key to be engaged into said key slot of said rotating shaft.
